(19) United States
(12) Patent Application Publication
(10) Pub. No.: US 2010/0029370 A1
(43) Pub. Date: Feb. 4, 2010

(54) Response time derivation and game

(75) Inventors: Nicholas James Robinson, London (GB); Nigel Richard Porter, Elstead (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: Orbis Technology Limited, Middlesex (GB)

(21) Appl. No.: 12/012,363

(22) Filed: Jan. 31, 2008

Related U.S. Application Data
(60) Provisional application No. 60/901,382, filed on Feb. 15, 2007.

(51) Int. Cl. A63F 9/24; A63F 13/00

(52) U.S. Cl. 463/25; 463/29; 463/30; 463/42

(57) ABSTRACT

Methods and apparatus for deriving a response time to a challenge in a network, and to a knowledge based quiz game suitable for use with the methods and apparatus.

This application claims the benefit of the filing date of U.S. provisional application Ser. No. 60/901,382 that was filed on 15 Feb. 2007.

### FIELD OF THE INVENTION

The present invention relates to methods and apparatus for deriving a response time to a challenge in a network, and also to a knowledge based quiz game suitable for use with the methods and apparatus.

### BACKGROUND OF THE INVENTION

A quiz is a form of game or mind sport in which the players (as individuals or in teams), attempt to answer questions correctly. Quizzes may be held on a variety of subjects (general knowledge, ‘pot luck’) or subject-specific.

Obfuscated code is source code that is (usually intentionally) very hard to read and understand. Code obfuscation techniques are used to protect software from reverse engineering.

U.S. patent application Ser. No. 10/472,286 (also published as WO02/079955) the disclosure of which is hereby incorporated herein by reference, describes certain non-limiting examples of code obfuscation techniques.

U.S. Pat. No. 5,970,143 describes a computer device and method for encoding a message corresponding to an outcome of a computer game, and a computer device and method for decoding the message to detect a fraudulent outcome. The computer device used to generate the encoded message includes (1) a memory device containing encoding control code and (2) a processor configured to process the encoding control code in conjunction with a computer game outcome to generate an encoded message containing the computer game outcome and to transmit the encoded message to a human-readable output device, such as a display device. The computer device includes various tamper resistant or tamper evidence features. A secure module containing the processor and memory is used to plug into an existing personal computer or dedicated game device.

U.S. Pat. No. 6,659,861 describes an Internet-based system for enabling a time-constrained competition among a plurality of participants over the Internet. The Internet-based system comprises: a primary server having an embedded global positioning system (GPS) receiver; one or more web servers for providing information about the competition on the World Wide Web (WWW); a login server for enabling participants to log-in with the system prior to the competition; a competitor/participant database for storing information about each participant registered to participate in the competition; an invitation-to-respond/response database for storing invitations-to-responds (ITRs) (e.g. queries, problems, etc.) to be simultaneously displayed to participants at the competition, as well as the responses provided by each of the participants in response to the ITRs; one or more competition-promoting servers, each having an embedded GPS receiver, and conducting the competition process; and a plurality of GSU-enabled client machines. Each GSU-enabled client machine has an embedded Global Synchronization Unit (GSU). Each GSU-enabled client machine enables a registered participant to receive and display ITRs simultaneously with each and every other participant, and provide time and space (TS) stamped responses to the competition promoting servers. The competition promoting server fairly determines a winner among the participants independent of network latencies. All such components are interconnected with a globally-extensive network (e.g. the Internet) to enable the competition among the participants.

U.S. patent application Ser. No. 10/293,228 (also published as U.S. 2004/0093372) describes a method whereby a condition on a client that is communicating with a server is determined by issuing a challenge to the client, causing the client to produce a response indicative of the condition. The server compares the response to an expected response to determine if the condition is as expected, and if not, takes appropriate action, such as terminating the connection with the client. The challenge preferably includes parameters and a code segment that causes the client to produce the response by executing the code segment. The code segment could perform a one-way hashing algorithm of a portion of memory indicated in the parameters. The server can thus determine if the client is using a modified basic input output system, modified software, pirated software, or whether other conditions exist on the client. The challenge can be changed to prevent the client from returning a false, predetermined response to the challenge.

U.S. Pat. No. 6,394,899 describes a knowledge based wagering game which affords a plurality of players an opportunity to place a wager on the game. A sequential series of questions is displayed to each player who must select a correct answer from a plurality of possible answers within a predetermined period of time. The answers selected by each player are recorded and the players are ranked with respect to all of the other players based on the number of correct answers selected and the amount of time taken to select the answers. Under a pari-mutuel betting system payouts are made in accordance with the players' relative scores.

The following references, the disclosures of which are hereby incorporated herein by reference, describe a number of non-limiting examples of code obfuscation techniques:
B. Barak, O. Goldreich, R. Impagliazzo, S. Rudich, A. Sahai, S. Vadhan, K. Yang, “On the (Im)possibility of Obfuscating Programs”, Advances in Cryptology, Proceedings of Crypto'2001, Lecture Notes in Computer Science, Vol. 2139, pp. 1-18.
Chow, S., Gu, Y., Johnson, H. & Zakharov, V. A. (2001), An Approach to the Obfuscation of Control-Flow of Sequential Computer Programs. In the proceedings of 4th International Conference on Information Security, LNCS Volume 2200. Springer-Verlag. Malaga, Spain.
Nagra, J. & Thomborson, C. (2004), Threading Software Watermarks. In the proceedings of 6th International Workshop on Information Hiding, LNCS Volume 3200, Springer-Verlag. Toronto, ON, Canada.
Hohl, F. (1998), Time limited blackbox security: Protecting mobile agents from malicious hosts. In the proceedings of 2nd International Workshop on Mobile Agents, LNCS Volume 1419, Springer-Verlag. Stuttgart, Germany.
Collberg, C., Thomborson, C. & Low, D. (1998), Manufacturing Cheap, Resilient, and Stealthy Opaque Constructs. In the proceedings of 1998 ACM SIGPLAN-SIGACT Symposium on Principles of Programming Languages (POPL'98). San Diego, Calif., USA.
Lamport, L. (1978), Time, clocks and the ordering of events in a distributed system. In Communications of the ACM, 21(7):558-565.
Chase, C. & Garg, V. K. (1995), Detection of global predicates: Techniques and their limitations. In the Journal of Distributed Computing, Volume 11, Issue 4, pages 191-201. Springer-Verlag.
Tomas Sander and Christian F. Tschudin. Protecting mobile agents against malicious hosts. In Mobile Agent Security, LNCS 1419. 1998.
J. Algesheimer, C. Cachin, J. Camenisch, and G. Karjoth. “Cryptographic security for mobile code”, Procceedings of 2001 IEEE Symposium on Security and Privacy, Oakland, May 2001, pp. 2-11
C. Collberg and J. Thomborson, Watermarking, Tamper-Proofing, and Obfuscation—Tools for Software Protection, University of Arizona Technical Report 2000-0, February 2000.
C. Collberg, C. Thomborson, and D. Low, “Breaking Abstractions and Unstructuring Data Structures”, Proc. IEEE Int'l Conf. Computer Languages (ICCL '98), May 1998, www.cs.auckland.ac.nz/collberg/Research/Publications/CollbergThomborsonLow 98b/.
C. Collberg, C. Thomborson, and D. Low, “Manufacturing Cheap, Resilient, and Stealthy Opaque Constructs”, Proc. Symp. Principles of Programming Languages (POPL '98), January 1998. www.cs.auckland.ac.nz/collberg/Research/Publications/CollbergThomborsonLow 98a/.
C. Collberg, C. Thomborson, and D. Low, “A Taxonomy of Obfuscating Transformations”, Technical Report 148, Dept. of Computer Science, Univ. of Auckland, July 1997, www.cs.auckland.ac.nz/˜collberg/Research/Publications/CollbergThomborsonLow97a.
D. Aucsmith, Tamper Resistant Software: An Implementation, Information Hiding: 1st Int. Workshop (Lecture Notes in Computer Science), vol. 1174, R. J. Anderson, Editor, Springer Verlag, 1996, Berlin, pp. 317-333.
C. Wang, J. Hill, J. Knight and J. Davidson, Software Tamper Resistance: Obstructing Static Analysis of Programs University of Virginia Technical Report available in PDF form from www.citeseer.nj.nec.com/wang00software.html

The disclosures of all references mentioned above and throughout the present specification, as well as the disclosures of all references mentioned in those references, are hereby incorporated herein by reference.

### SUMMARY OF THE INVENTION

There is provided in accordance with an embodiment of the present invention a method of deriving a response time to a challenge in a network, the method including: receiving an executable package, the executable package including: an encrypted challenge; obfuscated decryption code operable to decrypt the encrypted challenge thereby forming a decrypted challenge; and obfuscated encryption code operable to encrypt a response to the decrypted challenge thereby forming an encrypted response; making a first call into the executable package at a first call time to retrieve and decrypt the encrypted challenge; storing the first call time; making a second call into the executable package at a second call time to encrypt a response to the decrypted challenge; and deriving the response time to the challenge from a difference between the first call time and the second call time.

Preferably, the network includes a server and a client, the receiving the executable package includes receiving the executable package from the server.

Preferably, the obfuscated encryption code is further operable to encrypt the time to provide a response to form an encrypted time.

Preferably, the method further includes: sending the encrypted time and the encrypted response to the server.

Preferably, the server performs obfuscation of decryption code to form the obfuscated decryption code and obfuscation of encryption code to form the obfuscated encryption code.

Preferably, the obfuscation is performed dynamically by the server.

Preferably, the obfuscation is performed dynamically by altering the obfuscation for subsequent challenges sent by the server.

Preferably, the executable package is bound to the client.

There is also provided in accordance with a further embodiment of the present invention a device connected in operation to a client, the device operable to derive a response time to a challenge, the device including: a decryptor operable to decrypt an encrypted challenge received from the client to form a decrypted challenge; an encryptor operable to encrypt a response to the decrypted challenge received from the client to form an encrypted response; and a timer operable to time the interval between decrypting the encrypted challenge and encrypting the response, thereby deriving the response time.

There is also provided in accordance with another embodiment of the present invention a device connected in operation to a client, the device operable to derive the response time to a challenge, the device including: decryption means for decrypting an encrypted challenge received from the client to form a decrypted challenge; encryption means for encrypting a response to the decrypted challenge received from the client to form an encrypted response; and timing means for timing the interval between decrypting the encrypted challenge and encrypting the response, thereby deriving the response time.

There is also provided in accordance with a further embodiment of the present invention a method of deriving a response time to a challenge in a network, the method including: receiving an encrypted challenge; decrypting the encrypted challenge at a first time; receiving a response to the encrypted challenge; encrypting the response at a second time; and deriving the response time to the challenge from a difference between the first time and the second time.

Preferably, the network includes a server and a client, the receiving the encrypted challenge comprises receiving the encrypted challenge from the client, the receiving the response comprises receiving the response from the client, the method further including: encrypting the time to provide the response to form an encrypted time; and sending the encrypted time and the encrypted response to the client.

There is also provided in accordance with another embodiment of the present invention a method of playing a knowledge based wagering game, the method including the steps of: presenting a knowledge based game to a plurality of individuals; affording a first individual of the plurality of individuals an opportunity to place an opening wager on the game; affording one or more further individuals of the plurality of individuals an opportunity to place a matching wager on the game, wherein the matching wager matches the opening wager; accepting the opening wager placed by the first individual and any matching wager placed by the one or more further individuals to form a wager pool; displaying to wagerers a series of inquiries; affording the wagerers an opportunity to provide a response to each inquiry in the series of inquiries; recording the responses to each inquiry of the series of inquiries provided by wagerers; ranking the wagerers in dependence on the responses provided; and paying out a proportion of the wager pool to a top ranked wagerer.

Preferably, the recording further includes recording a response time to the series of inquiries; and the ranking further comprises ranking the wagerers in dependence on the response times.

Preferably, the displaying further includes displaying to the wagerers a plurality of possible responses to each inquiry in the series of inquiries; the affording further comprises affording the wagerers an opportunity to select a response from the plurality of possible responses to each inquiry in the series of inquiries; and the recording further comprises recording the responses selected by the wagerers.

Preferably, the recording further includes recording a response time to the series of inquiries; and the ranking further comprises ranking the wagerers in dependence on the response times.

Preferably, prior to displaying the inquiries, the method further includes: affording wagerers an opportunity to place a larger wager, wherein the larger wager is greater in value than any previous wager placed by another wagerer; and affording any wagerer who wagered less than the larger wager an opportunity to increase the value of their wager to the value of the larger wager.

Preferably, the proportion of the wager pool includes the entire wager pool.

Preferably, the presenting further includes presenting the category of the knowledge based game to the plurality of individuals.

Preferably, after the accepting step and before the displaying step the method further includes: presenting a sub-category of the knowledge based game to the plurality of individuals; affording the first individual of the plurality of individuals an opportunity to place a larger wager on the game; affording the one or more further individuals of the plurality of individuals an opportunity to place a matching larger wager on the game, wherein the matching wager matches the larger wager; and accepting the larger wager placed by the first individual and any matching larger wager placed by the one or more further individuals into the wager pool.

Preferably, the method further includes: transmitting to clients of the plurality of individuals an executable package, the executable package including: an encrypted series of inquiries; obfuscated decryption code operable to decrypt the encrypted series of inquiries thereby forming the series of inquiries; and obfuscated encryption code operable to encrypt the responses to the series of inquiries thereby forming an encrypted response; wherein the recording a response time to the series of inquiries includes, at each of the clients: storing a first call time when a first call is made into the executable package to retrieve and decrypt the encrypted series of inquiries; recording a second call time when a second call is made into the executable package to encrypt the responses to the series of inquiries; and deriving the response time to the series of inquiries from a difference between the first call time and the second call time; and receiving from the clients the response times.

Preferably, the method further includes: transmitting to clients of the plurality of individuals an encrypted series of inquiries; wherein the recording a response time to the series of inquiries includes, at each of the clients: sending the encrypted series of inquiries to a device connected to the client; decrypting the encrypted series of inquiries at a first time thereby forming the series of inquiries; receiving the series of inquiries from the device; sending the responses to the series of inquiries to the device; encrypting the responses to the series of inquiries at a second time thereby forming an encrypted response; and deriving the response time to the series of inquiries from a difference between the first time and the second time; and receiving from the clients the response times.

### BRIEF DESCRIPTION OF THE DRAWINGS

The present invention will be understood and appreciated more fully from the following detailed description, taken in conjunction with the drawings in which:

FIGS. 1-5 are screen shots from a quiz operated and played in accordance with embodiments of the present invention;

FIG. 6 illustrates a network topology of four clients involved in an instance of a game operated and played in accordance with embodiments of the present invention;

FIG. 7 illustrates one of the clients of FIG. 10;

FIG. 8 illustrates the contents of a one-time, auto-generated secure executable (OTAGSE) constructed in accordance with embodiments of the present invention; and

FIG. 9 is a diagram showing the sequence of operations between a server, a client and a OTAGSE in accordance with an embodiment of the present invention.

### DETAILED DESCRIPTION OF EMBODIMENTS

The conventional quiz game has become somewhat stagnant and boring with a simple question and answer format. According to the present invention, in certain embodiments thereof, there is provided a new format of quiz that adds excitement into the game process before any questions have even been asked. The excitement that is added into the game process is poker style betting options.

The quiz (hereinafter called Hyper Quiz) is a quiz that is played by 2-8 players (for example) who are arranged around a table (virtual or otherwise). Play preferably takes place in a clockwise direction. A question category is revealed; then the players preferably bet in turn around the table in the same way as poker; i.e. they are able to raise the bet, call the bet or fold (pull out of the betting). Preferably, the players bet upon their strength of knowledge of the question category, with the likelihood of answering the most multiple choice questions on this category in an allotted time (e.g. 5 questions, 10 seconds each). Alternatively, players bet upon their strength of knowledge of the question category, with the likelihood of answering a series of multiple choice questions (e.g. 3) in the category at a speed greater than the other players. Preferably, the sub category of the question is revealed at the end of the first round of betting—players will then have a better idea of the nature of the questions. The players take turns to bet in a clockwise fashion during the betting phase. Players may “fold” (i.e. drop out of the action), “call” (i.e. match the current bet) to keep in on the action, or “raise” the bet, increasing the stakes for the game. When the betting phase is over, the players remaining in the game (i.e. those who have not ‘folded’) will be asked a series of multiple choice questions on the previously stated topic in succession; preferably the player who answers the most correct questions in the allotted time is declared the winner. Alternatively, the player who answers the most questions correctly in the shortest time is declared the winner. The winner takes the “pot” of money invested by the players (preferably minus a percentage for the house (game organizer)). In the event of a tie, the pot is preferably divided equally amongst the winners.

The game can be played on various electronic media, e.g. interactive television, the Internet (for example via a Flash application) and Internet Protocol Television (IPTV), or in person on an actual gaming table. A percentage of the winners can also be drawn at random to play the game live on a TV game show. The game can be played in a number of different formats, e.g. in tournaments (where players play the games for points with cash prizes for the winners); on various virtual gaming tables (where each table has a betting limit from low bet limit tables for low budget players to no bet limit tables for high budget players), the various tables being presented to the players via a ‘lobby’ which will be described in more detail below; on an actual gaming table (for example, on a TV show played live in a TV studio (optionally using winners from the other two game formats)). Other formats will be apparent to someone skilled in the art.

In certain embodiments the player who answers the most questions correctly in the shortest time is declared the winner. Preferably, in electronic version of the game, the time to answer the questions is measured at the client, rather than at the server in order to be operated as fairly as possible and not discriminate against clients with slower network connections.

According to the present invention, in certain embodiments thereof, there are also provided methods and apparatus for frustrating cheating in network-based games by configuring a client to make two separate calls into executable code that is dynamically provided by a server. The first call made by the client is to obtain the questions whilst the second call made by the client converts the user's answers into a format acceptable to the server. By configuring the client to run this executable code at these two points in time, code can be included in the executable to calculate the elapsed time between the two calls. By using machine code obfuscation, performed dynamically by the server, a cheating client can be prevented from trivially extracting the questions from the executable code without running the code and can be stopped from trivially generating a valid response containing a forged elapsed time value. The client executes arbitrary machine code and therefore the use of a digital code signing mechanism ensures that the code originated from a trusted source. In this way the elapsed time to answer can be calculated at the client (in order to prevent bias against genuinely high latency connections) and it can be ensured that the reported elapsed times are accurate and cannot be subverted by dishonest clients.

The embodiments of the HyperQuiz game that will now be described (by way of example only) are played by players via a Flash application using a personal computer or on interactive television (TV).

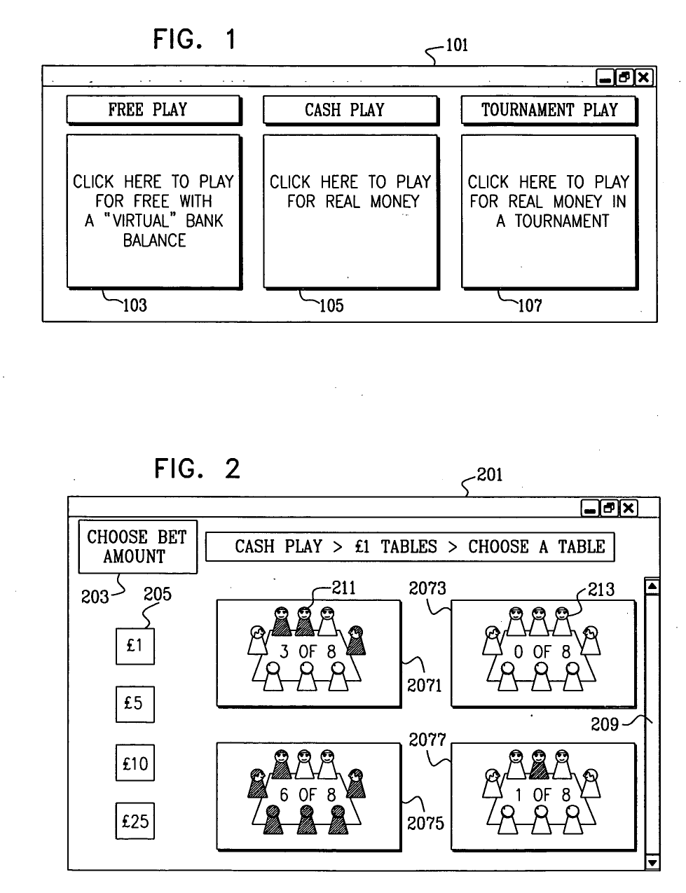

Upon loading the game (e.g. by running the Flash application), players are presented with a ‘Lobby’ screen like the ‘Lobby’ screenshot 101 shown in FIG. 1.

In order to play the game, the player:
Decides which variant of game they want to play (‘Free Play’; ‘Cash Play’; ‘Tournament Play’);
Chooses a tournament type (if they decided to opt for ‘Tournament Play’); and
Joins a suitable game table in their selected game category.

More details for each of these steps will now be described below.

### Choosing a Suitable Variant of the Game to Play

Across the ‘Lobby’ screen 101, the player is presented with three buttons: Free Play button 103; Cash Play button 105; and Tournament Play button 107. Each button represents a variant of the Hyper Quiz game, as described below.

Free Play—If the ‘Free Play’ variant of the game is selected (e.g. by clicking on Free Play button 103), the player can try the HyperQuiz game for free with a “virtual” bank balance. Preferably, there is no need to register to play the ‘Free Play’ game variant. The player will optionally be asked to choose a name and picture for themselves, which will be displayed to other players who also selected to play the ‘Free Play’ Hyperquiz variant.

Cash Play—If the ‘Cash Play’ variant of the game is selected (e.g. by clicking on Cash Play button 105), players play the game for real money. If ‘Cash Play’ is selected, the player is requested (e.g. via on screen messages/prompts) to log in (if he/she has previously registered his/her details with the HyperQuiz game operator) or to register (if he/she has not previously registered any details with the Hyperquiz game operator). By electing to register and following some on-screen instructions, the player is able to set up a personal, online HyperQuiz account (which may, for example, include choosing a user name and password; and registering some credit card details or depositing some funds in a personal, online ‘Hyperquiz’ account). If the player has already registered, the player is prompted to log in to the Hyperquiz game (e.g. by entering some of his/her account information (e.g. username and password) in a log in section.

Tournament Play—If the ‘Tournament Play’ variant of the game is selected (e.g. by clicking on Tournament Play button 107), the player can enter various tournaments. There are different types of tournaments to enter, with different entry fees, different prizes, different durations (e.g. daily, weekly etc.) etc. If the ‘Tournament Play’ game variant is selected, the player will be presented with a log in/register screen as was described above in relation to the ‘Cash Play’ option.

### Selecting a Suitable Tournament Type (‘Tournament Play’ Variant Only)

Before a player can join a game table in ‘Tournament Play’, the player selects which type of tournament they want to play in (e.g. via on screen messages/prompts). After selecting ‘Tournament Play’, a screen loads which shows all of the tournament types available and their descriptions. As was described above, there are different types of tournaments to enter, with different entry fees, different prizes, different durations, etc. When a player finds a particular tournament that he/she is interested in, he/she clicks on it and the information about the tournament loads. For example, if the player wants to play one of the daily tournaments with a fixed entry fee, he/she would select that tournament (e.g. by clicking an on screen button.) By registering for a tournament, any tournament fee due to be paid by the player to the game operator is deducted from the player's personal HyperQuiz account.

### Joining a Suitable Table to Play the Game (all Game Variants)

After the player has selected a variant of the HyperQuiz game to play, and has registered or logged in (as appropriate), he/she joins a game table in order to play the game.

For example, a player selects the ‘Cash Play’ variant of the game and registers and/or logs in. The player is then presented with the ‘Cash Play’ default screen 201, as shown in FIG. 2.

On the left hand side of the screen, under a ‘Choose Bet Amount’ tab 203, the player is presented with a column of buttons each button representing a game table cash value. The game table cash values represent the minimum bets for various groups of game tables that are available to play on. In the present embodiment, the £1 bet amount is selected by the player (e.g. by clicking on the £1 game table cash value button 205. In other embodiments, for example if the ‘Tournament Play’ game variant was selected, the various tournament types available to participate in would be displayed here instead of cash values.

With the £1 bet amount selected, a ‘Choose a Table’ section on the screen reveals all of the game tables that have a £1 minimum bet and that are available to join at that time. The game tables are represented by game table icons 2071/2073/2075/2079, which preferably comprise clickable buttons enabling a player to click on a game table in order to join that game table. The screen displays four game tables at a time (for example); if there are more game tables available, a scroll bar 209 on the right hand side of the screen allows the player to scroll down through all of the game tables that are available.

In the present embodiment, each game table icon comprises a graphic representation of a game table with eight surrounding players represented by illuminated player icons 211 and/or unilluminated player icons 213. A player icon is illuminated for each player that has selected to join a particular game table. Players looking for a game table to join are therefore able to tell how many additional players are needed to start each game by counting the un-illuminated player icons 213 on each game table. The number of players that have joined each game table is also preferably depicted in words in the centre of the game table icon. For example, three players have already selected to join game table number one (represented by game table icon 2071) and therefore three of the eight player icons surrounding the game table are illuminated. Furthermore, the text “3 of 8” in the centre of the game table icon indicates that three of the eight available places at game table number one have already been filled.

As mentioned previously, each of the game table icons preferably functions as a button, i.e. if a player wants to join a particular game table, he/she clicks on the respective game table button. The player is then represented on the chosen game table as an additional, illuminated player icon. In the present embodiment, when the eighth player joins a particular game table, the game will begin. In alternative embodiments, a game can begin with fewer than eight players (e.g. if the first two players who joined the game table agree to place their starting bets (which will be described in more detail below)). This is implemented, for example, via a talkback area and an OK pop up window.

Referring now to FIG. 3, after selecting a game table to join and the game beginning, the player is presented with the main HyperQuiz game screen 301.

Each player participating at the game table is represented by a mini-screen positioned around the virtual game table (e.g. mini-screen 303). Where a position around the game table is not filled by a player, a “waiting for player icon” 304 preferably appears in place of the mini-screen.

Referring now to FIG. 4, each player's mini-screen contains information used to play the HyperQuiz game. For example, mini-screen 303 contains: a player icon 305 (a graphic representation of the player optionally chosen during registration—if no player icon is chosen, a default player icon can optionally be displayed); a player profile button 307—which other player's can click on to see the profile of a particular player; player name 309—the name registered by the player during registration (e.g. the player's real name or an alias the player wants to use during the game); balance 311—the amount of money the player brought into the game plus/minus any amount the player has won/lost during the game; total current bet during play 313—the amount of money invested in each particular game; betting state of player 315—whether a player has called a previous bet, raised a previous bet or folded (to be described in more detail below).

The mini-screens are joined together by a track 315 comprising chevrons 317. Chevrons 317 indicate the direction of play and can be illuminated to indicate the player needing to take some form of action during the game (e.g. chevron 319). When a player needs to take some form of action in the game, the personal mini-screen of the player who needs to take action will preferably glow (or change color) and illuminated chevrons will point to that player's mini-screen. The details of the player who needs to take action also appear on the bottom left of the screen. When the player has taken the appropriate action, the next set of chevrons (e.g. in a clockwise direction) will be illuminated to point to the next player's mini-screen, indicating that the next player needs to take some particular action.

The centre of Hyperquiz game screen 301 comprises information box 321 and option boxes 323/325/327/329. In the betting phase of the game (to be described in more detail below), information box 321 provides details about the question category and the current pot total; and option boxes 323/325/327/329 comprise betting buttons that are clickable by a player to indicate his/her betting intentions. In the questions phase of the game (also to be described in more detail below), information box 321 provides the question to be answered by the players; and option boxes 323/325/327/329 comprise clickable buttons which contain four possible answers to the question presented in information box 321 and which are clickable by a player to indicate his/her answer to the question (as shown in FIG. 5).

In the present embodiment, when a player first joins a game table, a pop up window opens, asking the player how much money he/she would like to bring to the game table. If there is a minimum or maximum amount allowed at the particular game table, those amounts are preferably displayed in the pop window. When the player has selected the amount they would like to take to the game table, he/she clicks an ‘ok’ button to confirm the amount and to load his/her details into the “waiting for player” space that has been allocated to him/her. The player's name and graphical representation is then optionally displayed in the allocated space.

The rules of the Hyperquiz game will now be described in more detail.

The game is played on a “virtual table” by 2-8 players (for example). In the present embodiment, a player is drawn at random to start the game and go first. In alternative embodiments, the player who was first to join the particular game table goes first. Play takes place, for example, in a clockwise direction around the table.

The Hyperquiz game is divided into two main phases:

1. A Betting phase; and

2. A Questions phase.

### The Betting Phase

The betting phase will now be described. In the description that follows, it will be assumed that the table on which the game is being played has a £1 minimum bet.

A question category (e.g. geography) is revealed on screen in information box 321. Everyone who is playing the game places bets in turn in accordance to their strength of knowledge on that question category. Alternatively, no category is revealed on screen, or a category entitled “Random” is displayed on screen. Each player is betting on the likelihood of answering more questions correctly than the other players.

The 1st player places a £1 bet (i.e. a bet at the table minimum) (in the present embodiment, this process happens automatically and an ‘OK’ on-screen pop up message confirms the bet).

The 2nd player (in the present embodiment, the player immediately clockwise to the first player) places a £2 (i.e. a bet at double the amount of the table minimum) (in the present embodiment, this process happens automatically and ‘OK’ on-screen, pop up message confirms the bet).

These opening two bets (the bet placed by the 1^{st} and 2^{nd} players) are known as the ‘small blind’ and ‘big blind’ respectively and guarantee a ‘pot’ of money for each round of questions.

In alternative embodiments, the two opening bets placed by the 1^{st} and 2^{nd} players are identical. In yet further embodiments, only the 1^{st} player places a bet and the 2^{nd} player (and subsequent players) has a choice of whether to bet or not.

It is now the turn of the player in the next clockwise position (3rd player). The 3rd player in the game has three options:

1) CALL—Match the highest bet placed thus far (i.e. the £2 bet of the 2nd player)—In the present embodiment, option button 329 is available for the 3rd player to click on.

2) RAISE—Place a bet larger than the highest bet placed thus far. In the present embodiment, the bet can be raised in units of the minimum bet for the table (i.e. in units of £1 in the present embodiment) by using the plus and minus buttons of option button 323 to set the amount the 3rd player wants to raise the bet to. Each click of the respective button will increase or decrease the value of the bet in units of the minimum bet for the table being played. Option button 325 (marked “Raise”) is available for the 3rd player to click on when they are happy with the value that they are going to raise the bet.

3) FOLD—Drop out of the game—In the present embodiment, option button 327 (marked “Fold”) is available for the 3rd player to click on. Any money the 3rd player has already invested in the game up to that point will be lost.

As mentioned previously, in the present embodiment, the question category is displayed above the betting buttons in information box 321. The amount displayed underneath the question category is the current pot total, which consists of all the money bet so far in the current game. As each player bets in turn, the pot increases by the value of each bet. The eventual winner will win the pot (minus any nominated percentage for the house).

The 3rd player now chooses one of the three options described above by clicking on the appropriate on-screen button. When a player has selected one of the three bet options, the selected option will appear in the player's mini-screen for the other players to see, as previously described in relation to FIG. 4.

In the present embodiment, each player has 10 seconds to make their selection. If a player does not make a selection in time, if the bet has not been raised, a default “Call” bet is made on their behalf. If, however, the bet has been raised and the player does not make a selection in time, a default “Fold” bet is made on their behalf.

The next player is presented with the same three options (i.e. call, raise or fold) and so on until:

(a) Only one player remains because all the other players have folded; or

(b) A round of betting occurs with no player raising the bet.

This represents the end of a first stage of betting.

In alternative embodiments, the players have only two choices: CALL or FOLD.

In the present embodiment, at the end of the first stage of betting, the question sub-category is revealed. Once the sub-category has been revealed, a second stage of betting optionally takes place until:

(a) Only one player remains because all the other players have folded; or

(b) A round of betting occurs with no player raising the bet.

At the end of the betting phase (whether it comprises one or two stages of betting), if only one player remains because all the other players have folded, the remaining player takes the “winners pot” without having to answer any questions. The game ends and another game can then start.

If more than one player remains, all of the players still in the game up to that point qualify to play the questions phase of the game, which will be described in more detail below.

Referring once again to FIG. 3, in the depicted game there are seven players around the game table. The small blind (a £1 bet) was placed by Antonio and the big blind (a £2 bet) was placed by Vladimir. Tarquin and Dr. Rubinstein both elected, in turn, to call by placing a £2 bet (to match the highest previously placed bet). Mr. Black elected to fold and Suzie also elected to call by placing a £2 bet. The illuminated chevrons indicate that it is the turn of Anastasia to raise, call or fold.

### The Questions Phase

In the present embodiment, once the betting phase has finished and if more than one player remains in the game, all players remaining in the game attempt to answer the questions. Any player who folds during the betting phase of play is not allowed to answer the questions.

Preferably, any player still in the game at this stage will have their player icon still illuminated, whilst those players that have folded will have their player icon dimmed. Alternatively, the player icons can be colored differently depending on whether a player remains in the game or has elected to fold.

The question phase automatically begins by the first question being delivered in the centre of the screen on the question category already disclosed.

In the present embodiment, the questions are multiple-choice questions where four possible answers are presented to the players for each question posed. In alternative embodiments, more or less than four possible answers could be displayed. In yet other embodiments, the question may not be multiple choice questions but may require the full input of an answer by a player.

Referring once again to FIG. 5, in the present embodiment, each possible answer is displayed in its own option box labeled A, B, C or D and each containing a possible answer to the question. To submit an answer, a player clicks on the option box that they believe contains the correct answer. Players are preferably given a predetermined amount of time (e.g. 10 seconds) to submit an answer with a visual timer 322 showing the remaining time to answer in the question window.

When the predetermined period of time to answer has expired, the next question will be displayed and the process continues until a predetermined number of questions (e.g. three to five questions) have been displayed to each player.

When the time has elapsed for all the questions, in the present embodiment, the player who answered the most questions correctly is declared the winner and is awarded the pot.

In alternative embodiments, the total time taken for each player to provide an answer to all the questions is recorded and the player who answered the most questions in the quickest time is declared the winner.

The winner receives all the money invested into the game minus any percentage that the house (the game organizer) subtracts from the pot (which is variable but 5% for example). In the event of a tie, the pot is divided equally amongst all players who answered the most questions correctly. The next game/round of questions is started by the player immediately clockwise to the player who started the previous game.

A further embodiment of the Hyperquiz game will now be described. In this embodiment of the Hyper Quiz game, the game is played between four networked clients. A betting phase as described above takes place initially and after the betting phase of the game has been completed, each client is provided a set of questions to answer. Users at each of the four clients respond to the questions and, in the event of a tie, the user that answered the questions in the shortest period of time is deemed the winner.

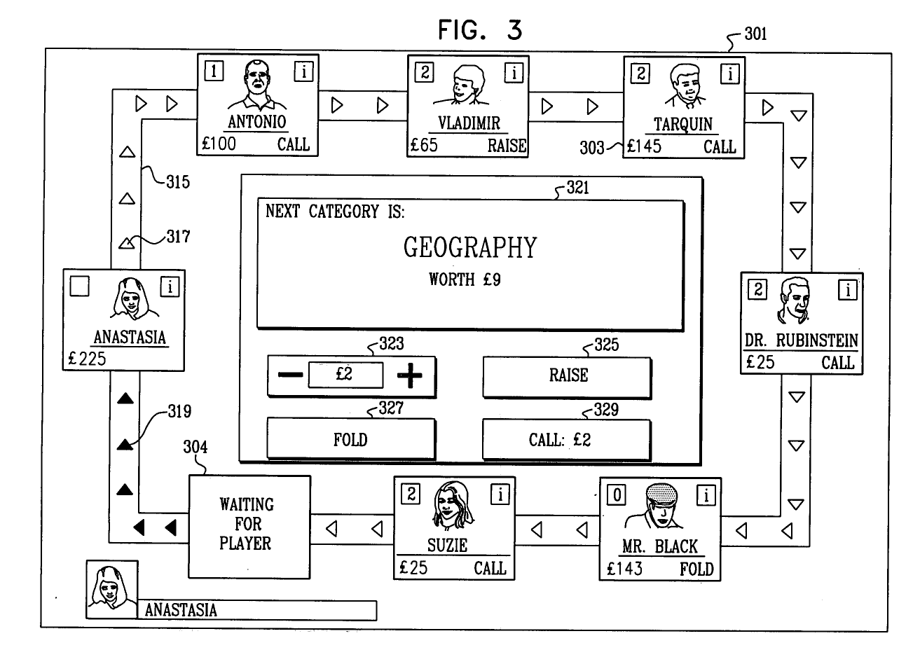

FIG. 6 shows the network topology of the present embodiment (for both client/server and peer-to-peer connectivity). Client A 601, Client B 603, Client C 605 and Client D 607 are each connected to a server 609 over a network. The solid lines in FIG. 6 indicate client/server links whilst the broken lines in FIG. 6 represent client/client links. The average single Ethernet packet round-trip times are indicated for each network link. For example, the average single Ethernet packet round trip time for the network link between Client A 601 and server 607 is 20 ms. For the sake of clarity, not all links are shown in FIG. 10.

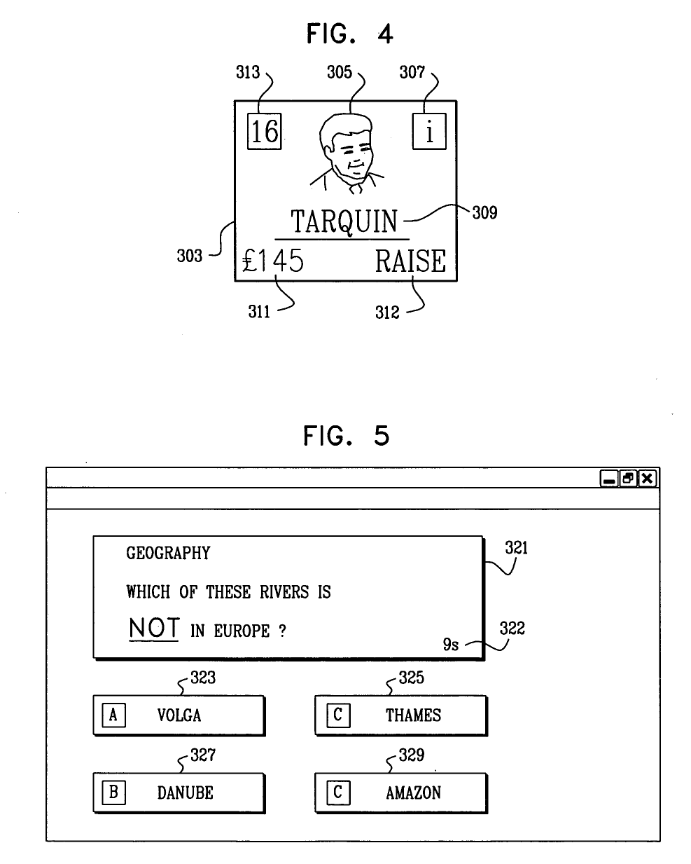

To be operated as fairly as possible, the game is operated so as to not discriminate against those players playing the game via a slower network connection, and therefore the time to answer the questions is measured on the client, rather than on the server. However, in order to cheat, clients may attempt to lie about the time it took for the player to answer the question(s). For example, network lag can be synthesized in an attempt to convince the server that the time delay was due to delivering the data via the network and not in answering the questions. This is illustrated in FIG. 7, which shows client B 603 cheating by adding a 2000 ms delay to all network traffic (i.e. for all common internet communication protocols such as the Internet Control Message Protocol (ICMP), the Address Resolution Protocol (ARP), the Transmission Control Protocol (TCP), the User Datagram Protocol (UDP) etc.) and thus making it appear to the server (and other clients) that it (client B 603) is attached to a slow network connection. If the client is trusted to report the time taken to answer the question(s) then this synthesized network latency gives the cheating client/player an additional 2 seconds of thinking time and therefore an unfair advantage.

According to embodiments of the present invention, the proposed solution to this problem calculates the elapsed time to answer on the client (in order to prevent bias against genuinely high latency connections) but also ensures that the reported elapsed times are accurate and cannot be subverted by dishonest clients.

According to embodiments of the present invention, the client makes two separate calls into executable code that is dynamically provided by the server. The first call into the executable code that is made by the client is to obtain the questions for the player to answer whilst the second call made by the client into the executable code converts the player's answers into a format acceptable to the server. By configuring the client to run this executable code at two points in time, additional code can be included in the executable code to calculate the elapsed time between the two calls into the executable code.

Moreover, by using machine code obfuscation to obfuscate the executable code, and by configuring the server to perform the obfuscation dynamically (i.e. to change the obfuscation used for each instance of the executable code), the cheating client can be prevented from trivially extracting the questions from the executable code without running it and can be stopped from trivially generating a valid response containing a forged elapsed time value. The client is configured to execute arbitrary machine code and therefore a digital code signing mechanism is preferably used to ensure that the executable code originated from a trusted source (i.e. the server).

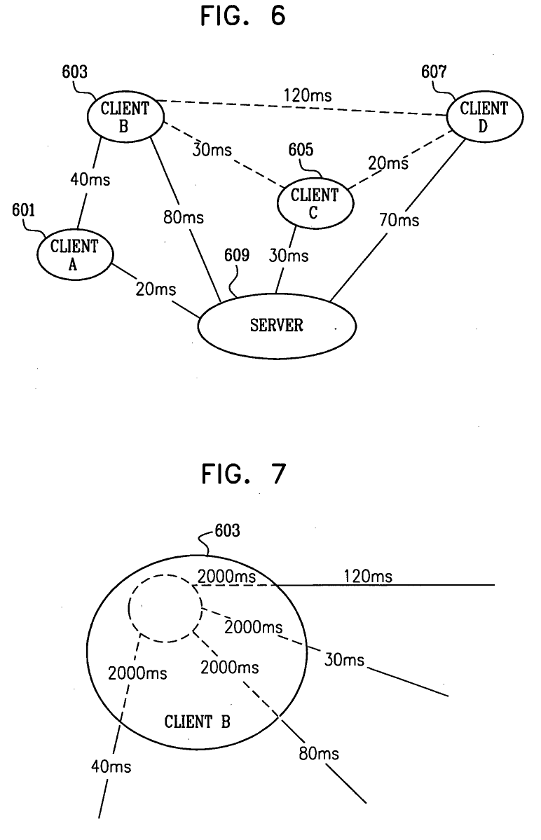

The executable code provided by the server to the client will hereinafter be referred to as a One-Time Auto-Generated Secure Executable (OTAGSE). Referring now to FIG. 8, the OTAGSE 800 includes: obfuscated machine code 801 including: the algorithm for decryption of the encrypted questions; the algorithm for encrypting the answers to the questions; and additional code to calculate the elapsed time between the two calls made by the client into the executable code; the encrypted questions 803; an encryption key 805 used to encrypt the answers to the questions that are to be sent to the server; and a digital signature 807 for use by the client in verifying the identity of the server.

The OTAGSE 800 is depicted in FIG. 8 as a simple sequence of data. However this is merely for the ease of understanding and depiction. It is to be noted and someone skilled in the art will appreciate that the actual structure of the OTAGSE 800 will not be a simple sequence of data. Rather, the order and layout of the components 801, 803, 805, 807 of OTAGSE 800 will be arbitrarily determined by the server 609 when the OTAGSE 800 is generated, and will preferably differ for each OTAGSE. This is to prevent someone trivially extracting the encryption key 805 or some other element from the OTAGSE 800.

The obfuscation process makes use of anti-disassembly and anti-debugging techniques as would be known to someone skilled in the art including:
Code transformations, in which the machine code of executable software is deliberately made significantly less human-readable, while still retaining the same functionality. Code obfuscation techniques include:
   opaque predicates, expressions whose behavior is constant and known well in advance by the obfuscator, although appear to be genuine conditional branches to those attempting to reverse engineer the software;
   redundant code (i.e. that which is never actually executed) and honey pots (code which appears to perform an operation of interest to a reverse engineer, although is actually a deliberate distraction);
   table interpretation, in which code is broken up and rearranged in a non-linear order in a table. A conditional expression is used to determine, at the time of execution, the order in which the code chunks are executed from the table to restore the original order. As such, sequential analysis of the code is rendered far more difficult for the reverse engineer;
   code interleaving (i.e. performing more than one task simultaneously in a single section of code and thread of execution);
   using threads to divide the functionality required by a given operation (i.e. make each thread perform a part of the operation, and synchronize them as necessary, to complicate interactive debugging);
   inlining (in which the code from functions is expanded and inserted ‘inline’ into each location where the function is called in order to flatten the structure of the resulting executable) and outlining (in which random sections of code are moved to a separate function to create misleading structure in the resulting executable);
   removing standard function signatures that may be especially interesting to reverse engineers, for example cryptographic protocols;
   introducing machine code that has no high level programming language equivalent, in order to frustrate attempts at disassembly of the machine code to a higher level language;
   flattening branches to remove call graph flow information and convert the code to a small number of large finite state machine (FSM)/switch statements in order to disrupt the structure of the program; and
   remove direct calls into standard, or operating system, libraries.
Data transformations, in which the representation and structure of data used by the executable software is deliberately made significantly less human-readable, while still retaining its purpose. Data obfuscation techniques include:
   splitting up variables, such that they are manipulated separately but need to be considered together in order to preserve the original meaning;
   specialized encoding/interpretation of data variables (e.g. representing a Boolean variable by a floating point variable, with a arbitrary value representing ‘true’ and all other values representing ‘false’);
   mapping to different number systems (e.g. representing all values in an arbitrary number base, or using an arbitrary co-ordinate system solely for the purpose of obfuscation);
   replacing static, or constant, values with a call to a function which calculates, and returns, the value algebraically;
   using algebraic equivalences rather than direct calculation; and
   merging unrelated data sets.

Other code obfuscation techniques and data obfuscation techniques will be apparent to someone skilled in the art.

By the use of a combination of the above techniques, the server can be made capable of generating a very large number of unique OTAGSEs, such that it is not computationally feasible for a cheating client to reverse engineer the obfuscated machine code, and therefore not possible for a cheating client to forge a correctly encrypted response, in the time required to participate interactively in the game, i.e. in the time provided for answering the questions and submitting the answers.

Code obfuscation techniques are widely used to protect software, as assets, from reverse engineering (e.g. the security of Microsoft Windows Media DRM and Apple iTunes Fairplay DRM is believed to be extensively based on code obfuscation). Preferably, the obfuscation varies with each question and therefore sufficient protection can be provided for the limited time it is required for (i.e. the time required to participate in the game). A single OTAGSE being reverse engineered is not considered to be a problem since it only needs to be ensured that the information obtained by such reverse engineering cannot be applied to automatically reverse engineer future OTAGSEs fast enough to be used to cheat in the Hyper Quiz game (i.e. within a number of seconds). People skilled in the art will appreciate this to be computationally unfeasible without significant resources, which an opportunist hacker is unlikely to have access to.

The knowledge learned by subsequent, off-line, reverse engineering of one or more OTAGSEs should not provide a reliable method by which to generate a tool capable of automatically reverse engineering OTAGSEs received in the future in the time required to participate interactively in the game. This is preferably achieved by combining a large and varying number of the above techniques in a random order and with randomly selected parameters, where applicable.

To further aid security, and also to increase the resilience to reverse engineering, the OTAGSE also preferably employs anti-debugging techniques to prevent interactive execution. This means that techniques are used that prevent an attacker running the OTAGSE code within a debugger, whilst single-stepping through the code to understand how it works, and/or how to modify it to remove the security checks and generate a false response. These techniques include detecting an attached debugger (by using processor registers and low-level operating system services), using multiple threads, looking for suspicious delays in program execution, calculating and verifying checksums of the code (to check for breakpoint insertion), using object code encryption, multiple threads of execution and kernel-mode code to spread the protection, etc.

In the present embodiment, the contents of the OTAGSE are assembled and packaged by the server for the client's platform (e.g. as a Dynamically Linked Library (DLL) for a client running the Microsoft Windows operating system).

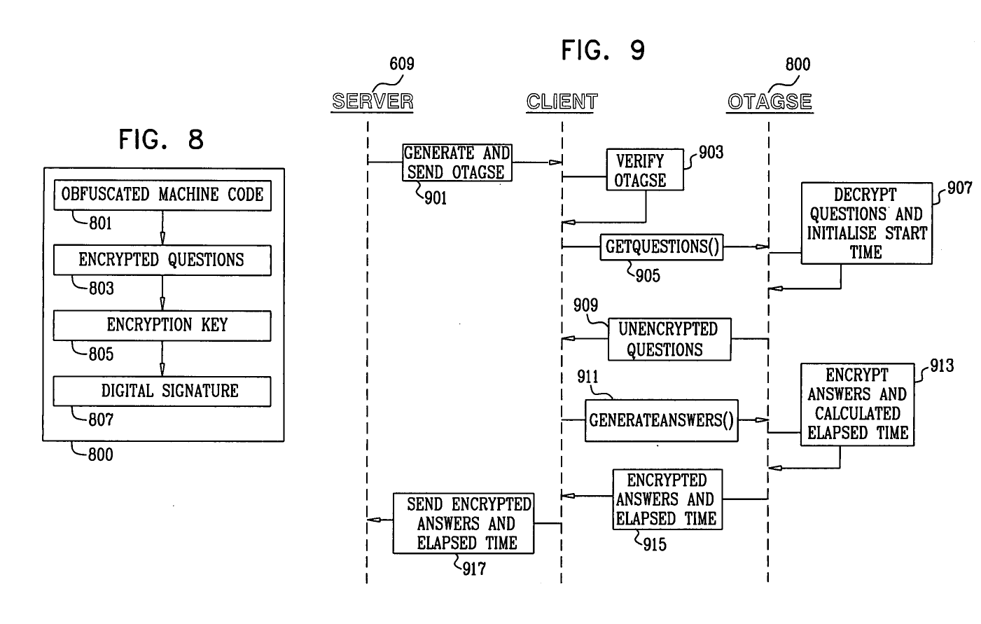

Referring now to FIG. 9, the sequence of operations between the server 609, a client and the OTAGSE 800 (when executed by the client's Hyperquiz software) will now be described.

Initially, server 609 generates the OTAGSE and sends it to the client (step 901). In the present embodiment, server 609 sends copies of the same OTAGSE to all the clients involved in the questions phase of the Hyperquiz game. In alternative embodiments, server 609 may send a different OTAGSE to each client involved in the questions phase of the Hyperquiz game although the questions contained in the multiple differing OTAGSEs will be the same for each client for any particular one question phase of the Hyperquiz game. In such embodiments, the obfuscation performed by server 609 on each of the OTAGSEs is preferably different.

On receiving the OTAGSE from server 609, and before any of the executable code is invoked, the digital signature contained within the OTAGSE is verified (step 903), using the public key certificate of server 609 that has been previously stored by the client.

Once a valid signature is confirmed by the client, the client software first executes a function, called GetQuestions, provided within the OTAGSE (step 905). The GetQuestions( ) function decrypts the encrypted questions that server 609 embedded within the OTAGSE; obtains the current time (i.e. the time at which the GetQuestions( ) function is called); and stores this time in an obfuscated format in memory within the client that is allocated to the OTAGSE (step 907). Then, the decrypted questions are returned to the client (step 909) for presentation to the player.

Once the client software has obtained the answers to the questions from the user/player, the client software executes a function, called GenerateAnswers, also provided by server 609 within the OTAGSE (step 911). The GenerateAnswers( ) function obtains the current time (i.e. the time at which the GenerateAnswers( ) function is called); calculates the elapsed time taken to answer the questions (by subtracting the current time from the previously stored time); and the answers to the questions and the elapsed time are then encrypted using the server private encryption key that server 609 also embedded within the OTAGSE (step 913). The encrypted answers and the encrypted elapsed time are then returned to server 609, via the client software, for consideration (steps 915/917).

The start and end times (i.e. the times when the GetQuestions( ) and GenerateAnswers( ) functions are executed) are obtained from the client platform in as secure a manner as possible. The precise mechanism is platform dependent and does not typically only make use of the standard system clock, as the standard system clock can be easily manipulated. Instead, either multiple time sources are preferably used together, or a lower-level, hardware based time source is preferably employed. This reduces the risk of a dishonest client tampering with the time source to make it appear that the dishonest client took less time than it actually did.

For example, on an Intel Pentium architecture machine running the Microsoft Windows operating system, the start and end times (and therefore the elapsed time) may be obtained from one or more of the following sources:
Calling Microsoft Windows operating system time services (exposed by functions such as GetSystemTime, NtQuerySystemTime, GetSystemTimes, GetTickCount etc). The system WM_TIMECHANGE event can also be trapped (otherwise referred to as handled) to learn about any deliberate attempts to change the system time whilst the question is being answered;
Calling Microsoft Windows operating system high resolution timers (exposed by functions such as QueryPerformanceCounter and QueryPerformanceCounterFrequency);
Querying the Pentium Time Stamp Counter (TSC) Model Specific Register (MSR). The Pentium architecture processors implement a 64-bit time stamp counter which monotonically increases with each clock cycle, even if the processor is halted. It can be examined from user mode (via the RDTSC or RDMSR instructions), and modified from kernel mode (via the WRMSR instruction), but any modification is easily detected as only the low order 32-bits (which obviously change very rapidly) can be specifically set, resulting in the top 32-bits being reset to 0. To determine the time interval, the difference between two successive values of the TSC register can be calculated with the result being divided by the clock speed of the processor.

Preferably, techniques such as binding the OTAGSE to an individual client machine (e.g. by hard disk volume ID, Microsoft Windows operating system serial number, CPU ID etc.) and making use of operating system kernel synchronization objects (e.g. mutexes and semaphores) and/or secure, persistent storage of data (e.g. in the registry) in order to prevent two instances of the OTAGSE from being executed concurrently or sequentially on the same machine, and to prevent the OTAGSE from being executed on a machine other than the one for which it was generated. This is beneficial in preventing an attack whereby a dishonest client runs the software once to obtain the questions, and then again after determining the answer to the question—if the second invocation results in a new start timestamp being generated by the executable then the client could appear to have legitimately answered the questions more quickly than they actually did.

In some embodiments, tamper-proof hardware is used to replace the need for OTAGSEs, and to provide a much higher level of security. For example, a USB device could be implemented, the USB device containing a tamper-proof secure clock and implementations of the required cryptographic algorithms. The USB device receives encrypted questions and generates encrypted answers (timing the interval between each). This eliminates the requirement for the use of software obfuscation or anti-debugging techniques as the code to decrypt the questions and generate the response would not be executed on the PC platform, but instead on the tamper-proof hardware device.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

What is claimed is:

1. A method of deriving a response time to a challenge in a network, said method comprising:
receiving an executable package, said executable package comprising:
an encrypted challenge;
obfuscated decryption code operable to decrypt said encrypted challenge thereby forming a decrypted challenge; and
obfuscated encryption code operable to encrypt a response to said decrypted challenge thereby forming an encrypted response;
making a first call into said executable package at a first call time to retrieve and decrypt said encrypted challenge;
storing said first call time;
making a second call into said executable package at a second call time to encrypt a response to said decrypted challenge; and
deriving the response time to said challenge from a difference between said first call time and said second call time.

2. The method of claim 1, wherein said network comprises a server and a client, said receiving said executable package comprises receiving said executable package from said server.

3. The method of claim 2, wherein said obfuscated encryption code is further operable to encrypt said time to provide a response to form an encrypted time.

4. The method of claim 3, said method further comprising: sending said encrypted time and said encrypted response to said server.

5. The method of claim 2, wherein said server performs obfuscation of decryption code to form said obfuscated decryption code and obfuscation of encryption code to form said obfuscated encryption code.

6. The method of claim 5, wherein said obfuscation is performed dynamically by said server.

7. The method of claim 5, wherein said obfuscation is performed dynamically by altering said obfuscation for subsequent challenges sent by said server.

8. The method of claim 1, wherein said executable package is bound to said client.

9. A device connected in operation to a client, said device operable to derive a response time to a challenge, said device comprising:
a decryptor operable to decrypt an encrypted challenge received from said client to form a decrypted challenge;
an encryptor operable to encrypt a response to said decrypted challenge received from said client to form an encrypted response; and
a timer operable to time the interval between decrypting said encrypted challenge and encrypting said response, thereby deriving said response time.

10. A device connected in operation to a client, said device operable to derive the response time to a challenge, said device comprising:
decryption means for decrypting an encrypted challenge received from said client to form a decrypted challenge;
encryption means for encrypting a response to said decrypted challenge received from said client to form an encrypted response; and
timing means for timing the interval between decrypting said encrypted challenge and encrypting said response, thereby deriving said response time.

11. A method of deriving a response time to a challenge in a network, said method comprising:
receiving an encrypted challenge;
decrypting said encrypted challenge at a first time;
receiving a response to said encrypted challenge;
encrypting said response at a second time; and
deriving the response time to said challenge from a difference between said first time and said second time.

12. The method of claim 11, wherein said network comprises a server and a client, said receiving said encrypted challenge comprises receiving said encrypted challenge from said client, said receiving said response comprises receiving said response from said client, said method further comprising: encrypting said time to provide said response to form an encrypted time; and sending said encrypted time and said encrypted response to said client.

13. A method of playing a knowledge based wagering game, said method comprising the steps of:
presenting a knowledge based game to a plurality of individuals;
affording a first individual of said plurality of individuals an opportunity to place an opening wager on the game;
affording one or more further individuals of said plurality of individuals an opportunity to place a matching wager on the game, wherein said matching wager matches said opening wager;
accepting the opening wager placed by said first individual and any matching wager placed by said one or more further individuals to form a wager pool;
displaying to wagerers a series of inquiries;
affording said wagerers an opportunity to provide a response to each inquiry in said series of inquiries;
recording the responses to each inquiry of said series of inquiries provided by wagerers;
ranking the wagerers in dependence on said responses provided; and
paying out a proportion of the wager pool to a top ranked wagerer.

14. The method of claim 13, wherein said recording further comprises recording a response time to said series of inquiries; and said ranking further comprises ranking the wagerers in dependence on the response times.

15. The method of claim 13, wherein said displaying further comprises displaying to said wagerers a plurality of possible responses to each inquiry in said series of inquiries; said affording further comprises affording said wagerers an opportunity to select a response from said plurality of possible responses to each inquiry in said series of inquiries; and said recording further comprises recording the responses selected by said wagerers.

16. The method of claim 15, wherein said recording further comprises recording a response time to said series of inquiries; and said ranking further comprises ranking the wagerers in dependence on the response times.

17. The method of claim 13, wherein prior to displaying said inquiries, said method further comprises:
affording wagerers an opportunity to place a larger wager, wherein said larger wager is greater in value than any previous wager placed by another wagerer; and
affording any wagerer who wagered less than said larger wager an opportunity to increase the value of their wager to the value of said larger wager.

18. The method of claim 13, wherein said proportion of the wager pool comprises the entire wager pool.

19. The method of claim 13, wherein said presenting further comprises presenting the category of said knowledge based game to said plurality of individuals.

20. The method of claim 19, wherein after said accepting step and before said displaying step said method further comprises:
presenting a sub-category of said knowledge based game to said plurality of individuals;
affording said first individual of said plurality of individuals an opportunity to place a larger wager on the game;
affording said one or more further individuals of said plurality of individuals an opportunity to place a matching larger wager on the game, wherein said matching wager matches said larger wager; and
accepting the larger wager placed by said first individual and any matching larger wager placed by said one or more further individuals into said wager pool.

21. The method of claim 14, further comprising:
transmitting to clients of said plurality of individuals an executable package, said executable package comprising:
an encrypted series of inquiries;
obfuscated decryption code operable to decrypt said encrypted series of inquiries thereby forming said series of inquiries; and
obfuscated encryption code operable to encrypt the responses to said series of inquiries thereby forming an encrypted response;
wherein said recording a response time to said series of inquiries comprises, at each of said clients:
storing a first call time when a first call is made into said executable package to retrieve and decrypt said encrypted series of inquiries;
recording a second call time when a second call is made into said executable package to encrypt the responses to said series of inquiries; and
deriving the response time to said series of inquiries from a difference between said first call time and said second call time; and receiving from said clients the response times.

22. The method of claim 14, further comprising:
transmitting to clients of said plurality of individuals an encrypted series of inquiries;
wherein said recording a response time to said series of inquiries comprises, at each of said clients:
sending said encrypted series of inquiries to a device connected to said client;
decrypting said encrypted series of inquiries at a first time thereby forming said series of inquiries;
receiving said series of inquiries from said device;
sending the responses to said series of inquiries to said device;
encrypting the responses to said series of inquiries at a second time thereby forming an encrypted response; and
deriving the response time to said series of inquiries from a difference between said first time and said second time;
and receiving from said clients the response times.
